(19) United States
(12) Patent Application Publication
(10) Pub. No.: US 2005/0110796 A1
(43) Pub. Date: May 26, 2005

(54) Frame rate control systems and methods

(75) Inventors: Mark Flowers, Los Gatos, CA (US); Ilya V. Ivanchenko, Los Altos, CA (US); Venkat Aala, San Jose, CA (US); Charles R. Geber, Kamuela, HI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Leapfrog Enterprises, Inc., Emeryville, CA (US)

(21) Appl. No.: 10/967,094

(22) Filed: Oct. 15, 2004

Related U.S. Application Data
(60) Provisional application No. 60/512,321, filed on Oct. 17, 2003.

(51) Int. Cl. G09G 5/02

(52) U.S. Cl. 345/589

(57) ABSTRACT

A method of operating a pixel includes generating one of m possible data streams from an n-bit input that represents a desired intensity level. The data stream is usable to drive a pixel to the desired intensity level. Each of the m data streams includes a plurality of frames. The method further includes pseudo-randomly selecting a starting frame from the plurality of frames in the data stream for a specific pixel, using the selected data stream to drive the specific pixel, and pseudo-randomly selecting a different starting frame for a different specific pixel.

### CROSS-REFERENCES TO RELATED APPLICATIONS

This application is a non-provisional of, and claims the benefit of, co-pending, commonly assigned U.S. Provisional Patent Application No. 60/512,321, entitled, “METHOD AND SYSTEM FOR PROVIDING FRAME RATE CONTROL” (Attorney Docket No. 020824-007700), filed on Oct. 17, 2003, by Mark Flowers, et al., the entire disclosure of which is herein incorporated by reference for all purposes.

### BACKGROUND OF THE INVENTION

The present invention relates generally to display systems. More specifically, the present invention relates to systems and methods for providing grayscale using frame rate control.

Passive LCDs, such as the common STN display type, require display drive algorithms to generate shades of gray or multiple shades of color. STN display driver circuits are only capable of driving individual display pixels to either a full OFF or full ON condition. However, intermediate drive levels are required to generate shades of gray or other color. Intermediate levels are achieved by rapidly changing a pixel drive between ON and OFF resulting in the generation of a simulated intermediate drive level corresponding to the percentage of time that a pixel is driven ON. If the ON/OFF sequencing is fast relative to the visual response of the display, then an intermediate visual intensity level is achieved.

Various approaches can be used to alternate pixels between ON and OFF to generate intermediate drive levels. Some of these approaches utilize Frame Rate Control (FRC). FRC approaches or algorithms sequence pixel ON/OFF transitions on a frame by frame basis with each pixel driven either ON or OFF for an entire frame. Other common approaches use Pulse Width Modulations (PWM). PWM implementations generate pixel ON/OFF transitions within an individual frame.

FRC approaches typically result in slight flicker and some motion artifacts due to simulation of intermediate levels by ON/OFF drive sequencing from frame to frame. Straightforward FRC implementation uses fixed conversion of grayscale level to pixel ON/OFF state based on circular frame number. This approach creates significant flicker unless the rate of frame refresh is very high (500 Hz). Having a high refresh rate, however, is not practical because of high power consumption and low contrast that quickly diminishes with frame rate increase.

Some improved approaches use more sophisticated conversion of grayscale level to pixel ON/OFF state. Many flavors of improved FRC were developed but, in general, use phase shift that is different for each pixel position (phase depends on x-y position). As mentioned above, a number of simplistic implementations of FRC also exhibit another problem—“motion artifacts,” or certain motion visible in static images. The motion appears due to human visual detection. When high-frequency blinking appears, adjacent pixels that blink with the same sequence but with different phase create imaginary motion effect.

FRC algorithms are widely used in consumer and commercial products with monochrome and color passive LCDs. Product examples include PDAs, cell phones, digital cameras, and commercial equipment control panels. High performance LCDs with high resolution, such as a PC monitor, use TFT active displays which do not need FRC algorithms (active display drivers are capable of producing intermediate levels directly, therefore the algorithmic simulation of intermediate drive levels is not needed).

FRC algorithms have been widely known and used for many years. Algorithm implementations are generally in hardware (rather than software) due to the requirement for high speed processing. Most implementations have some amount of software programmability to enable visual results to be optimized for different display manufactures. Products with FRC driven LCDs are generally designed in one of two approaches: (1) product engineers purchase a graphics controller IC which has a proprietary FRC algorithm built in, or (2) product engineers design a custom system ASIC which contains the FRC function and LCD controller.

In the past decade, there has been a substantial market for graphic controller ICs with built-in FRC algorithms. Consequently, graphic controller IC manufacturers have invested heavily in the development of optimized and refined FRC algorithms. As a result, many graphic IC manufacturers have developed complex FRC algorithms with various claimed visual benefits. While many products with FRC algorithms now exist, it is still desirable to develop FRC algorithms that are designed specifically for a product specific ASIC to optimize product performance.

Furthermore, STN LCD has a non-linear response curve (perceived intensity vs. drive level) that washes out color difference in some parts of intensity range and spreads shades further apart in others. Usually, such response curve has a shape of S, when high and low levels have almost indistinguishable intensity and intensity of medium levels grow rapidly creating big steps. Such response curve results in unpleasant color distortions.

Moreover, different LCD panels behave differently with the same FRC algorithm. Some LCD panels behave better while some are worse with any fixed (non-programmable) FRC algorithm.

Hence, it is desirable to provide a system with an improved FRC algorithm that will, amongst other things, minimize creation of flicker and motion artifacts, and compensate for LCD non-linearity (gamma correction).

### BRIEF SUMMARY OF THE INVENTION

Embodiments of the present invention thus provide a method of operating a pixel. The method includes generating one of m possible data streams from an n-bit input that represents a desired intensity level. The data stream is usable to drive a pixel to the desired intensity level. Each of the m data streams includes a plurality of frames. The method further includes pseudo-randomly selecting a starting frame from the plurality of frames in the data stream for a specific pixel, using the selected data stream to drive the specific pixel, and pseudo-randomly selecting a different starting frame for a different specific pixel. The intensity level may be a grayscale intensity level. In some cases, n=4 and m=33. The specific pixel may be a color pixel, in which case the method may include, for two additional color components, generating one of m possible data streams from an n-bit input that represents a desired intensity level. The data stream may be usable to drive a pixel to the desired intensity level. Each of the m data streams may include a plurality of frames. The method may include pseudo-randomly selecting a starting frame from the plurality of frames in the data stream for a specific pixel, using the selected data stream to drive the specific pixel, and pseudo-randomly selecting a different starting frame for a different specific pixel.

In other embodiments, a computer-readable medium has stored thereon code for generating one of m possible data streams from an n-bit input that represents a desired intensity level. The data stream is usable to drive a pixel to the desired intensity level. Each of the m data streams includes a plurality of frames. The computer-readable medium also includes code for pseudo-randomly selecting a starting frame from the plurality of frames in the data stream for a specific pixel, and code for pseudo-randomly selecting a different starting frame for a different specific pixel.

In still other embodiments, a frame rate controller includes a lookup table configured to receive video data. The video data includes an intensity level for a pixel. The lookup table is configured to use the intensity level to select a frame sequence comprising a plurality of frames. The frame rate controller also includes a phase randomizer configured to identify a starting frame in the plurality of frames and a display interface configured to sequentially receive the frame sequence, starting with the starting frame, and direct the frame sequence to a pixel, thereby driving the pixel to the intensity level. The phase randomizer may be configured to identify, for a different pixel, a different starting frame in a frame sequence. The phase randomizer may be a Linear Feedback Shift Register.

In other embodiments, a video controller includes means for generating one of m possible data streams from an n-bit input that represents a desired intensity level. The data stream is usable to drive a pixel to the desired intensity level. Each of the m data streams includes a plurality of frames. The video controller also includes means for pseudo-randomly selecting a starting frame from the plurality of frames in the data stream for a specific pixel. The means for pseudo-randomly selecting a starting frame is configured to pseudo-randomly select a different starting frame for a different specific pixel. The video controller also includes means for using the selected data stream to drive the specific pixel. In some cases, m=2ⁿ⁺¹+1. In some cases, n=4 and m=33. The means for generating one of m possible data streams may be a lookup table.

In further embodiments, a method of operating a pixel includes receiving an n-bit input that represents a desired intensity level and generating a m-bit value representative of a data stream usable to drive a pixel to the desired intensity level. The data stream includes a number of active frames within a plurality of frames. The method further includes pseudo-randomly distributing the number of active frames throughout the plurality of frames and using the data stream to drive a specific pixel. The pixel may be a color pixel, in which case the method may include, for two additional color components, receiving an n-bit input that represents a desired intensity level and generating a m-bit value representative of a data stream usable to drive a pixel to the desired intensity level. The data stream includes a number of active frames within a plurality of frames. The method also includes pseudo-randomly distributing the number of active frames throughout the plurality of frames and using the data stream to drive the specific pixel.

Is still further embodiments, a computer-readable medium has stored thereon code for receiving an n-bit input that represents a desired intensity level, code for generating a m-bit value representative of a data stream usable to drive a pixel to the desired intensity level, wherein the data stream includes a number of active frames within a plurality of frames, and code for pseudo-randomly distributing the number of active frames throughout the plurality of frames.

In still other embodiments, a frame rate controller includes a lookup table configured to receive video data. The video data includes an intensity level for a pixel. The lookup table is configured to use the intensity level to determine a number of active frames within a plurality of frames. The frame rate controller also includes a pattern randomizer configured to distribute the active frames within the plurality of frames and a display interface configured to sequentially receive the plurality of frames and direct the frames to a pixel, thereby driving the pixel to the intensity. The intensity level may be a grayscale intensity level. The pattern randomizer may be configured to, for a different pixel, distribute the active frames within the plurality of frames differently. The pattern randomizer may be a Linear Feedback Shift Register.

In other embodiments, a video controller includes means for receiving an n-bit input that represents a desired intensity level and generating a m-bit value representative of a data stream usable to drive a pixel to the desired intensity level. The data stream includes a number of active frames within a plurality of frames. The video controller also includes means for pseudo-randomly distributing the number of active frames throughout the plurality of frames and means for using the data stream to drive a specific pixel.

In some embodiments of the present invention, a fully integrated system ASIC includes an FRC algorithm and an LCD driver interface. According to one exemplary aspect, there are two similar versions of the FRC algorithm. The FRC algorithm is designed based on a number of objectives including, for example: ability to take advantage of features offered by simple commonly-used approaches; ability to support monochrome and color displays; ability to provide software programmability so that the algorithm could be adjusted to optimize visual performance on different LCD panels.

According to one exemplary aspect, the FRC algorithm is designed to produce sixteen shades of intensity based on a 4-bit input value. The system uses the same FRC algorithm when configured for either monochrome or color displays. In the case of a monochrome display, sixteen shades of gray can be produced. In the case of a color display, the same algorithm is used to create sixteen shades each of red, green and blue per pixel. In this manner, a total of twelve bits per pixel control 4,096 possible colors. In one embodiment, the system is run in color mode with a color LCD panel.

In some embodiments, the system ASIC uses a passive STN LCD and an FRC algorithm. The system ASIC is additionally capable of interfacing to an active TFT LCD. In TFT mode, the FRC algorithm is disabled since TFT drivers can display intermediate levels directly.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a simplified block diagram of a FRC controller that implements a first exemplary FRC algorithm according to embodiments of the present invention.

FIG. 2 illustrates a lookup table used in association with the exemplary embodiment of FIG. 1.

FIG. 3 illustrates a simplified block diagram of a FRC controller that implements a second exemplary FRC algorithm according to embodiments of the present invention.

### DETAILED DESCRIPTION OF THE INVENTION

Embodiments of the present invention reduce visual artifacts in displays employing grayscale (color or monochrome) algorithms. In some embodiments, grayscale frame cycles are randomized spatially such that neighboring pixels generally experience different phases of the cycle. In some embodiments, active frames within a cycle are randomized. Exemplary embodiments are described in more detail hereinafter.

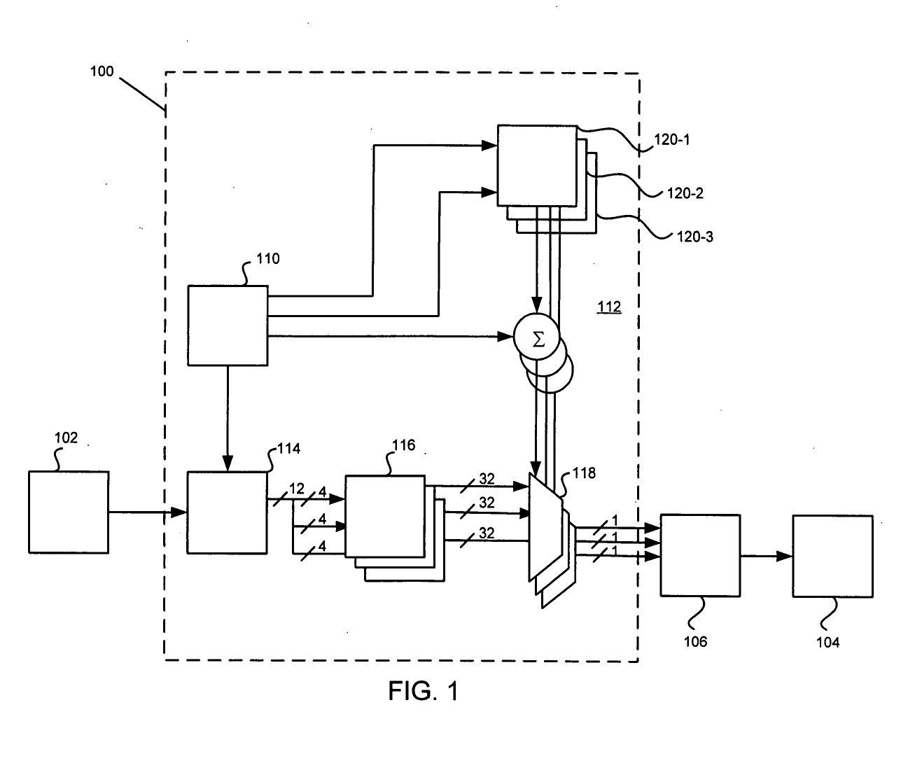

FIG. 1 illustrates a first example of a video controller 100 according to embodiments of the present invention. The controller 100 is merely exemplary of a number of embodiments according to the invention. The controller 100 may be embodied in an ASIC, or other appropriate device or arrangement. According to this example, the controller 100 implements a Frame Rate Control (FRC) algorithm that provides 4-bit grayscale per channel. Thus, the algorithm produces sixteen possible intensity levels when operating in monochrome mode and 4096 possible colors (sixteen color shades in three color channels) when operating in color display mode.

The FRC algorithm cycles through a sequence of thirty-two video frames. Within the 32-frame sequence, the algorithm directs an individual pixel (or individual pixel color components, e.g., red, green, and blue) to turn ON for n frames and OFF for 32-n frames. The resulting visual intensity of each pixel is proportional to the percentage of time that it is ON within the 32-frame sequence (i.e., proportional to the value of n).

In this embodiment, the controller 100 receives video data from a video data source, such as RAM 102, and sends pixel control signals to a display panel, such as LCD panel 104, via an interface, such as LCD interface 106. Although in this specific embodiment the controller 100 provides FRC for a color LCD panel, it should be apparent to those skilled in the art, that embodiments of the invention also may be used to provide FRC for a monochrome display or other displays.

The controller 100 includes a display timing generator 110, a phase randomizer 112, a data sequencer 114, a lookup table 116, and a multiplexer 118. The display timing generator 110 provides various clock signals and counters to properly sequence data through the controller 100. For example, signals provided from the display timing generator 110 to the data sequencer 114 are used to select appropriate data from the video RAM 102.

In this specific embodiment, data pass from the data sequencer 114 to the lookup table 116 in four bit groups, each group representing a grayscale level for a pixel or pixel color component. The four bit groups essentially address intensity levels from the lookup table 116. If multiple color components are included, each color component may have a different lookup table.

As mentioned previously, a grayscale cycle in this embodiment is thirty-two frames long. Thus, thirty-three intensity levels are possible as a result of pixel activation in n out of thirty-two frames where n can range from zero to thirty-two. However, only sixteen intensity levels are desired. The lookup table maps each of the sixteen grayscale levels to one of the thirty-three possible drive intensity levels.

In this specific embodiment, the lookup table performs two functions. First, the mapping of each of the sixteen grayscale levels to one of thirty-three possible drive intensity levels allows for the creation of an intensity control curve that matches the visual gamma response of an LCD panel. In other words, a one-quarter grayscale may not have exactly eight of the thirty-two frames ON to account for non-linearity in an LCD intensity curve. Second, the ON and OFF frames may be arranged within the 32-bit output so as to create a uniform or optimal distribution of the active frames within the 32-frame sequence. Such control of the frame pattern may minimize flicker, motion artifacts, and other undesired effects.

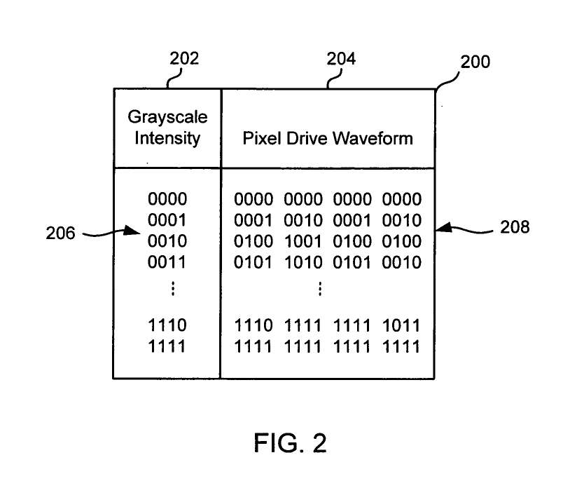

To implement the two functions described immediately above, the lookup table may be software programmable in the controller, which provides for some amount of visual fine tuning to accommodate variances from different LCD manufacturers. Hardware implementations may leverage one table of values to implement the same mapping function for the red, green and blue components. In some embodiments, optimal table values are empirically determined for a given LCD manufacturer and permanently fixed in base ROM code. Further, lookup tables for different colors may have different forms. An exemplary lookup table is illustrated in FIG. 2.

FIG. 2 illustrates a 4×32-bit lookup table 200 according to a specific embodiment of the invention. Four-bit grayscale intensity levels 202, received from the data sequencer 114, address 32-bit pixel drive waveforms 204 that provide thirty-three possible intensity levels. Only six of the sixteen gray scale intensity levels are shown for ease of illustration. In this exemplary embodiment, it is clear that the mapping of grayscale intensity levels 202 to pixel drive waveforms is not linear. For example, the third intensity level 206 corresponds to 2/16 gray. The corresponding pixel drive waveform 208, however, has five out of thirty-two ON frames. The difference in relative weighting accounts for non-linear LCD response characteristics and the like. Further, the five ON frames are distributed throughout the waveform to reduce or eliminate discernible visual artifacts that could occur if ON and OFF frames were grouped together. Those skilled in the art will appreciate other advantages in light of this disclosure.

Once selected from the lookup table 116, data for each color channel pass to multiplexers 118. Individual bits of the 32-bit sequence are selected from the multiplexer 118 using signals from the phase randomizer 112. As will be described in more detail below, bits are selected so as to spatially randomize the phase of the 32-bit sequence for each pixel.

Conventional FRC algorithms tend to generate perceived motion artifacts in intermediate intensity levels. These artifacts may be reduced by varying the phase of the FRC sequence for some pixels. In other words, while every pixel follows the same 32-frame FRC sequence, at any moment in time, some pixels will be at different counts (called phase) in the 32-frame sequence.

In some embodiments of the present invention, the system controller implements an approach to phase variation that works well with relatively low density of colors (4,096) and relatively low resolution (200×200 max). The phase of the 32-frame FRC sequence is varied for each pixel by a pseudo-random number generator 120. The net result is a (pseudo) random spatial distribution of pixel phase assignments across the display area. The pseudo-random number generator 120 is reset with the same seed every frame resulting in a constant pseudo-random phase pattern across the display area. In color mode, three independent pseudo random number generators 120-1, 120-2, 120-3 are used, one each for red, green and blue, which further randomizes the spatial phasing of FRC frames. In a specific embodiment, the pseudo random number generators 120 are Linear Feedback Shift Registers.

In this specific embodiment, linear feedback shift registers (LFSR) produce a random phase assignment spatially and repeat the pattern when re-seeded for the next frame. The frame counter is incremented to thereby cause each pixel to cycle through an entire intensity waveform before the next grayscale value is rendered in a subsequent 32-frame cycle. Those skilled in the art will appreciate other spatial randomization approaches other than using LFSRs. For example, in some embodiments, a pre-determined random phase value may be hard coded for each pixel, thus eliminating the need for pseudo-random number generation circuitry. Depending upon the number of pixels in the display, however, such embodiments may require more silicon real estate than the pseudo-random number generation circuitry.

In some embodiments, this approach has no algorithmic defined (other than pseudo random) or otherwise constrained spatial phase relationships, does not use a tiled or group of pixels approach to define phase variance, does not dither pixels, and/or has no temporal phase variance. The foregoing approach is further illustrated in pseudo-code below:
sequence=table[pixel]; (1)
{a 32-bit sequence is selected from a lookup table using a 4-bit grayscale value for a pixel}
phase=frame+X+Y+rnd(X)+rnd(Y); (addition modulo 32 is used) (2)
{a phase value is computed for a given pixel where: “frame” is a frame counter (counts from 0 to 31, i.e. 32 frames sequence); “X” is an X-counter (horizontal pixel position); “Y” is an Y-counter (vertical pixel position); “rnd(X)” is a pseudo-random generator for X with programmable seed, 15-bit wide LFSR (one for each color); “rnd(Y)” is a pseudo-random generator for Y with programmable seed, 9-bit wide LFSR (one for each color)}
out=sequence[phase]; (3)
{the pixel drive signal for a specific frame is selected from the sequence using the phase value}
X═X+1 for each pixel; Y═Y+1 for each line; reset rnd(X) and rnd(Y) at end of frame. (4)
{the pseudo-random generators 120 are reset after each frame and the pixel position counters are incremented appropriately (X pseudo-random generator advances once for each pixel, Y advances once for each line)}

In summary, the first embodiment of the FRC algorithm involves: fixed 32-frame FRC sequence; controlling intensity by driving a pixel n out of thirty-two frames, thus yielding thirty-three possible output intensity levels; mapping sixteen input levels to thirty-three possible output intensity levels; assigning a fixed distribution of n enabled frames within a 32-frame sequence for each intensity level; using one lookup table to define the intensity mapping and active frame distribution assignment; using a pseudo-random generator to create a spatial phase variance of the 32-frame FRC sequence for each pixel; using three pseudo-random generators to create different variances for each red, green and blue components; and no dithering, no tiled assignment of phase variances and no temporal phase variance.

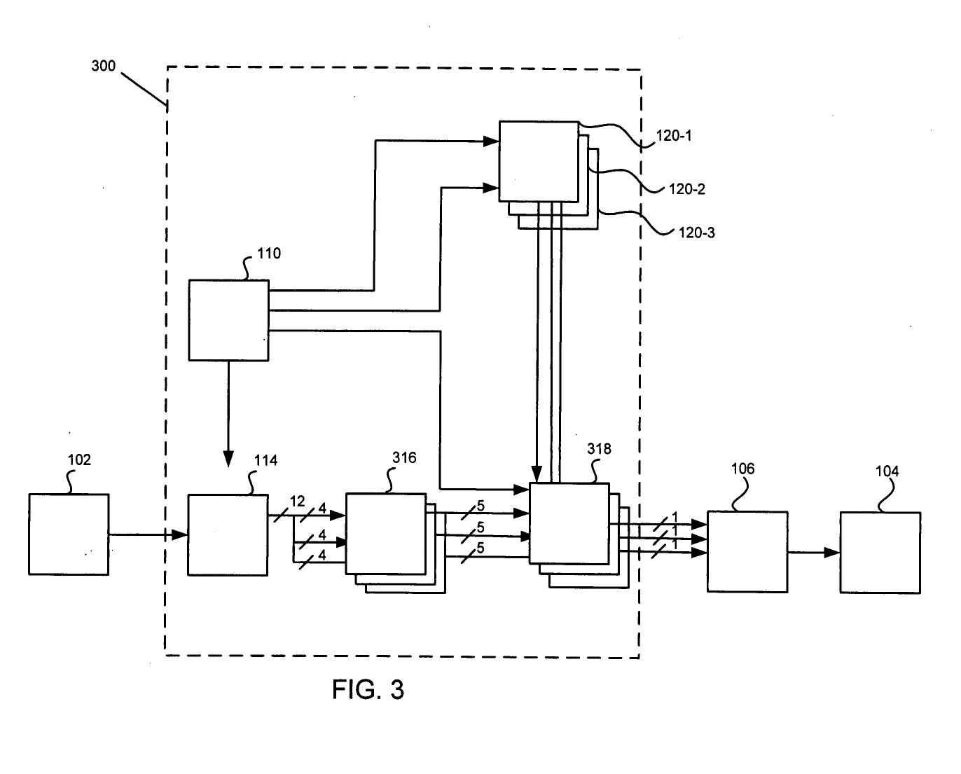

FIG. 3 illustrates a second exemplary video controller 300 according to embodiments of the present invention. The second video controller 300 is similar to the first video controller 100 in that it implements a 32-frame FRC algorithm. In this embodiment, however, the FRC algorithm generates pseudo-random frame pattern assignment between pixels. In other words, for any given intensity level having n active frames within a 32-frame sequence, the second embodiment varies the distribution locations of n active frames from pixel-to-pixel. The first embodiment implements an FRC algorithm that produces a constant pattern that distributes the n active frames within the thirty-two frame sequence. In the second embodiment, the FRC algorithm does not address phase since phase is meaningless if the pattern varies from pixel to pixel. This is an alternative approach to minimizing motion artifacts.

In this embodiment, the controller 300 receives video data from a video data source, such as RAM 102, and sends pixel control signals to a display panel, such as LCD panel 104, via an interface, such as LCD interface 106. The controller 300 includes a display timing generator 110, a pattern randomizer 318, a data sequencer 114, and a lookup table 316. The lookup table 316, in this specific embodiment, is a 4×5 bit table that maps sixteen grayscale intensity levels (four bits) to one of thirty-two possible gamma values represented by a 5-bit output.

The pattern randomizer includes a pseudo-random number generator 120 for each color channel and a pattern randomizer 318 for each color channel. The pseudo-random number generator(s) 120 may be LFSRs or other appropriate arrangement. The pattern randomizer 318 randomizes the distribution of ON frames within a 32-frame sequence from pixel-to-pixel according to the algorithm described in detail immediately hereinafter.
level=table[pixel]; (1)
{a pixel's 4-bit grayscale level is used to select one entry from the table, effectively converting it to a 5-bit value. If multiple colors are being rendered, then this function is performed once for each color}

$$\begin{matrix}A = ( frame [ 0 ] ? level [ 4 \text{:} 0 ] : 0 ) + \\ ( frame [ 1 ] ? ( level [ 3 \text{:} 0 ] << 1 ) : 0 ) + \\ ( frame [ 2 ] ? ( level [ 2 \text{:} 0 ] << 2 ) : 0 ) + \\ ( frame [ 3 ] ? ( level [ 2 \text{:} 0 ] << 3 ) : 0 ) + \\ ( frame [ 4 ] ? ( level [ 0 ] << 4 ) : 0 ) ; ( addition modulo 32 is used )\end{matrix} \qquad ( 2 )$$

B=A+level; (addition modulo 32 is used) (3)
{intermediate values A and B (5-bit each) are calculated (for each color). “Frame” is a frame counter (counts from 0 to 31, i.e. 32 frames sequence). Brackets “[ ]” represent bit numbers, Question Marks “?” represents conditional execution, Less Than operators “<<” represent shift left operation that is implemented by wiring}
range_min=1 when (phase >=A),
range_min=0 otherwise; (1-bit value) (4)
range_max=1 when (phase<B),
range_max=0 otherwise; (1-bit value) (5)
{two comparisons are performed}
phase=X+Y+rnd(X)+rnd(Y) (6)
{phase (5-bit value) is computed for each color were “X” is an X-counter (horizontal pixel position); “Y” is an Y-counter (vertical pixel position); “rnd(X)” is a pseudo-random generator for X with programmable seed, 15-bit wide LFSR (one for each color); “rnd(Y)” is a pseudo-random generator for Y with programmable seed, 9-bit wide LFSR (one for each color)}
OUT=1 when (level=31),
OUT=(range_min OR range_max) when (A>B),
OUT=(range_min AND range_max) for all other cases (1-bit value) (7)
{output pixel value (1-bit, ON or OFF) is calculated}
All pseudo-random generators are reset at the start of each frame. X pseudo-random generator advances once for each pixel, Y advances once for each line.

Any of the functions or methods described in this application can be embodied as code on a computer readable medium. The computer readable medium may comprise any suitable optical, electronic, or magnetic mode of data storage. The computer readable medium may be incorporated into an interactive apparatus using a display. In addition, code for any of the functions or methods described herein may be created using any suitable programming language including C, C++, etc.

Embodiments of the invention can be used in an interactive apparatus using a display screen. Examples of such interactive apparatuses are described in U.S. patent application Ser. Nos. 10/775,830, 10/776,012, 60/446,829, and 60/512,326, which are herein incorporated by reference in their entirety for all purposes.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software. Further, those skilled in the art will appreciate that the present invention is not limited to 4-bit grayscale algorithms, 32-bit drive sequences, RGB color displays, or any other specific embodiments described herein by way of example.

All references, patent applications, and patents mentioned above are herein incorporated by reference in their entirety for all purposes. None of them is admitted to be prior art to the presently claimed inventions.

1. A method of operating a pixel, comprising:
generating one of m possible data streams from an n-bit input that represents a desired intensity level, wherein the data stream is usable to drive a pixel to the desired intensity level, wherein each of the m data streams includes a plurality of frames;
pseudo-randomly selecting a starting frame from the plurality of frames in the data stream for a specific pixel;
using the selected data stream to drive the specific pixel; and
pseudo-randomly selecting a different starting frame for a different specific pixel.

2. The method of claim 1, wherein the intensity level comprises a grayscale intensity level.

3. The method of claim 1, wherein n=4 and m=33.

4. The method of claim 1, wherein the specific pixel comprises a color pixel, and wherein the method further comprises, for two additional color components:
generating one of m possible data streams from an n-bit input that represents a desired intensity level, wherein the data stream is usable to drive a pixel to the desired intensity level, wherein each of the m data streams includes a plurality of frames;
pseudo-randomly selecting a starting frame from the plurality of frames in the data stream for a specific pixel;
using the selected data stream to drive the specific pixel; and
pseudo-randomly selecting a different starting frame for a different specific pixel.

5. A computer-readable medium having stored thereon:
code for generating one of m possible data streams from an n-bit input that represents a desired intensity level, wherein the data stream is usable to drive a pixel to the desired intensity level, wherein each of the m data streams includes a plurality of frames;
code for pseudo-randomly selecting a starting frame from the plurality of frames in the data stream for a specific pixel; and
code for pseudo-randomly selecting a different starting frame for a different specific pixel.

6. The computer-readable medium of claim 5, wherein the specific pixel comprises a color pixel and wherein the computer-readable medium further comprises, for two additional color components:
code for generating one of m possible data streams from an n-bit input that represents a desired intensity level, wherein the data stream is usable to drive a pixel to the desired intensity level, wherein each of the m data streams includes a plurality of frames;
code for pseudo-randomly selecting a starting frame from the plurality of frames in the data stream for a specific pixel; and
code for pseudo-randomly selecting a different starting frame for a different specific pixel.

7. A frame rate controller comprising:
a lookup table configured to receive video data, wherein the video data includes an intensity level for a pixel, wherein the lookup table is configured to use the intensity level to select a frame sequence comprising a plurality of frames;
a phase randomizer configured to identify a starting frame in the plurality of frames; and
a display interface configured to sequentially receive the frame sequence, starting with the starting frame, and direct the frame sequence to a pixel, thereby driving the pixel to the intensity level.

8. The frame rate controller of claim 7, wherein the intensity level comprises a grayscale intensity level.

9. The frame rate controller of claim 7, wherein the phase randomizer is further configured to identify, for a different pixel, a different starting frame in a frame sequence.

10. The frame rate controller of claim 7, wherein the phase randomizer comprises a Linear Feedback Shift Register.

11. A video controller, comprising:
means for generating one of m possible data streams from an n-bit input that represents a desired intensity level, wherein the data stream is usable to drive a pixel to the desired intensity level, wherein each of the m data streams includes a plurality of frames;
means for pseudo-randomly selecting a starting frame from the plurality of frames in the data stream for a specific pixel, wherein the means for pseudo-randomly selecting a starting frame is configured to pseudo-randomly select a different starting frame for a different specific pixel; and
means for using the selected data stream to drive the specific pixel.

12. The video controller of claim 11, wherein the intensity level comprises a grayscale intensity level.

13. The video controller of claim 11, wherein the means for pseudo-randomly selecting a starting frame from the plurality of frames in a selected data stream for a specific pixel comprises a Linear Feedback Shift Register.

14. The video controller of claim 11, wherein m=2ⁿ⁺¹+1.

15. The video controller of claim 11, wherein n=4 and m=33.

16. The video controller of claim 11, wherein the means for generating one of m possible data streams comprises a lookup table.

17. A method of operating a pixel, comprising:
receiving an n-bit input that represents a desired intensity level;
generating a m-bit value representative of a data stream usable to drive a pixel to the desired intensity level, wherein the data stream includes a number of active frames within a plurality of frames;
pseudo-randomly distributing the number of active frames throughout the plurality of frames; and
using the data stream to drive a specific pixel.

18. The method of claim 17, wherein the intensity level comprises a grayscale intensity level.

19. The method of claim 17, wherein n=4, m=5, and the plurality of frames comprises 32 frames.

20. The method of claim 17, wherein the pixel comprises a color pixel and wherein the method further comprises, for two additional color components:
receiving an n-bit input that represents a desired intensity level;
generating a m-bit value representative of a data stream usable to drive a pixel to the desired intensity level, wherein the data stream includes a number of active frames within a plurality of frames;
pseudo-randomly distributing the number of active frames throughout the plurality of frames; and
using the data stream to drive the specific pixel.

21. A computer-readable medium having stored thereon:
code for receiving an n-bit input that represents a desired intensity level;
code for generating a m-bit value representative of a data stream usable to drive a pixel to the desired intensity level, wherein the data stream includes a number of active frames within a plurality of frames; and
code for pseudo-randomly distributing the number of active frames throughout the plurality of frames.

22. The computer-readable medium of claim 21, wherein the intensity level comprises a grayscale intensity level.

23. The computer-readable medium of claim 21, wherein the pixel comprises a color pixel and wherein the computer readable medium further comprises, for two additional color components:
receiving an n-bit input that represents a desired intensity level;
generating a m-bit value representative of a data stream usable to drive a pixel to the desired intensity level, wherein the data stream includes a number of active frames within a plurality of frames; and
pseudo-randomly distributing the number of active frames throughout the plurality of frames.

24. A frame rate controller comprising:
a lookup table configured to receive video data, wherein the video data includes an intensity level for a pixel, wherein the lookup table is configured to use the intensity level to determine a number of active frames within a plurality of frames;
a pattern randomizer configured to distribute the active frames within the plurality of frames; and
a display interface configured to sequentially receive the plurality of frames and direct the frames to a pixel, thereby driving the pixel to the intensity.

25. The method of claim 24, wherein the intensity level comprises a grayscale intensity level.

26. The method of claim 24, wherein the pattern randomizer is configured to, for a different pixel, distribute the active frames within the plurality of frames differently.

27. The method of claim 24, wherein the pattern randomizer comprises a Linear Feedback Shift Register.

28. A video controller, comprising:
means for receiving an n-bit input that represents a desired intensity level and generating a m-bit value representative of a data stream usable to drive a pixel to the desired intensity level, wherein the data stream includes a number of active frames within a plurality of frames;
means for pseudo-randomly distributing the number of active frames throughout the plurality of frames; and
means for using the data stream to drive a specific pixel.

29. The video controller of claim 28, wherein the intensity level comprises a grayscale intensity level.

30. The video controller of claim 28, wherein n=4, m=5, and the plurality of frames comprises 32 frames.

31. The video controller of claim 28, wherein the means for pseudo-randomly distributing the number of active frames throughout the plurality of frames comprises a Linear Feedback Shift Register.
